(19) United States
(12) Patent Application Publication
(10) Pub. No.: US 2021/0108854 A1
(43) Pub. Date: Apr. 15, 2021

(54) ARTIFICIAL INTELLIGENCE FOR REFRIGERATION

(71) Applicant: LG ELECTRONICS INC., Seoul (KR)

(72) Inventor: Sungae KIM, Seoul (KR)

(73) Assignee: LG ELECTRONICS INC., Seoul (KR)

(21) Appl. No.: 16/677,076

(22) Filed: Nov. 7, 2019

(30) Foreign Application Priority Data
Oct. 10, 2019 (KR) 10-2019-0125006

(51) Int. Cl. F25D 29/00; G06N 3/08; G06N 3/04; G05B 13/02

(52) U.S. Cl. CPC F25D 29/00; G06N 3/08; G06N 3/0445; F25D 2700/12; G05B 13/027; F25D 2400/28; G06N 3/0454

(57) ABSTRACT

An AI apparatus mounted in a refrigerator includes: an input interface configured to obtain environmental data; and a processor configured to provide the environmental data to an AI model, and to control the refrigerator to perform rapid refrigeration when a result of the AI model is greater than a first threshold. Accordingly, food stored in the refrigerator is stored in an appropriate condition without being spoiled.

### CROSS-REFERENCE TO RELATED APPLICATIONS

This application claims priority under 35 U.S.C. 119 and 35 U.S.C. 365 to Korean Patent Application No. 10-2019-0125006 filed on Oct. 10, 2019 in Korea, the entire contents of which is hereby incorporated by reference in its entirety.

### FIELD

The present disclosure relates to an artificial intelligence (AI) apparatus which can predict a probability of spoilage of food in a refrigerator based on environmental data, and performs rapid refrigeration according to a result of prediction.

### BACKGROUND

The present disclosure relates to an AI apparatus mounted in a refrigerator, and more particularly, to obtaining environmental data of an inside of a refrigerator to store food in each space of the refrigerator in an optimum storage condition, and controlling internal temperature of the refrigerator by performing rapid refrigeration by using an AI model.

If food is not well managed during hot summer, food is highly likely to spoil. When food spoils and rots, bacteria such as food poison easily propagate and thus special cautions are required to manage food.

Most of bacteria caused by food spoilage may not well propagate at temperature of plus 5 degree centigrade or lower, and food stored in a refrigerator compartment of a refrigerator does not easily spoil. However, even a well-designed refrigerator may have difficulty in maintaining ideal internal temperature due to various reasons, such as frequent opening and closing of the door of the refrigerator.

A related-art method for managing an internal environment of a refrigerator considering the above-described point uses a deodorization filter to remove a smell coming from spoiled food, or controls bacteria by using an antibacterial filter. Therefore, there is a need for a system for managing before food spoils.

### SUMMARY

The present disclosure provides an AI apparatus which predicts a probability of spoilage of food in a refrigerator based on environmental data, and performs rapid refrigeration according to a result of prediction.

An AI apparatus mounted in a refrigerator includes: an input interface configured to obtain environmental data; and a processor configured to provide the environmental data to an AI model, and to control the refrigerator to perform rapid refrigeration when a result of the AI model is greater than a first threshold. The result of the AI model is a food spoilage probability.

In this case, when the food spoilage probability is greater than an output threshold, the processor may control an output interface to output a notification, and the output threshold may be a value greater than the first threshold.

### BRIEF DESCRIPTION OF THE DRAWINGS

FIG. 1 is a block diagram illustrating an AI apparatus according to an embodiment of the present disclosure;

FIG. 2 is a block diagram illustrating an AI server according to an embodiment of the present disclosure;

FIG. 3 is a view illustrating an AI system according to an embodiment of the present disclosure;

FIG. 4 is a block diagram illustrating an AI apparatus according to an embodiment of the present disclosure;

FIG. 5 is a flowchart according to an embodiment of the present disclosure;

FIG. 6 is an AI model according to an embodiment of the present disclosure;

FIG. 7 is a flowchart according to an embodiment of the present disclosure;

FIG. 8 is a view illustrating an example of an output according to an embodiment of the present disclosure; and

FIG. 9 is a view illustrating an example of an output according to an embodiment of the present disclosure.

### DETAILED DESCRIPTION

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “interface” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for training data is given, and the label may mean the correct answer (or result value) that the artificial neural network must infer when the training data is input to the artificial neural network. The unsupervised learning may refer to a method of learning an artificial neural network in a state in which a label for training data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving interface may include an actuator or a motor and may perform various physical operations such as moving a robot joint. In addition, a movable robot may include a wheel, a brake, a propeller, and the like in a driving interface, and may travel on the ground through the driving interface or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

Here, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

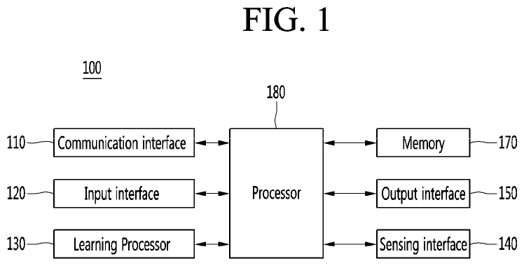

FIG. 1 is a block diagram illustrating an AI apparatus 100 according to an embodiment of the present disclosure.

Hereinafter, the AI apparatus 100 may be referred to as a terminal.

The AI apparatus (or an AI device) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI apparatus 100 may include a communication interface 110, an input interface 120, a learning processor 130, a sensing interface 140, an output interface 150, a memory 170, and a processor 180.

The communication interface 110 may transmit and receive data to and from external devices such as other 100a to 100e and the AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

Here, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a training data for model learning and an input data to be used when an output is acquired by using learning model. The input interface 120 may acquire raw input data. Here, the processor 180 or the learning processor 130 may extract an input feature by preprocessing the input data.

The learning processor 130 may learn a model composed of an artificial neural network by using training data. The learned artificial neural network may be referred to as a learning model. The learning model may be used to an infer result value for new input data rather than training data, and the inferred value may be used as a basis for determination to perform a certain operation.

Here, the learning processor 130 may perform AI processing together with the learning processor 240 of the AI server 200.

Here, the learning processor 130 may include a memory integrated or implemented in the AI apparatus 100. Alternatively, the learning processor 130 may be implemented by using the memory 170, an external memory directly connected to the AI apparatus 100, or a memory held in an external device.

The sensing interface 140 may acquire at least one of internal information about the AI apparatus 100, ambient environment information about the AI apparatus 100, and user information by using various sensors.

Examples of the sensors included in the sensing interface 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

Here, the output interface 150 may include a display interface for outputting time information, a speaker for outputting auditory information, and a haptic module for outputting haptic information.

The memory 170 may store data that supports various functions of the AI apparatus 100. For example, the memory 170 may store input data acquired by the input interface 120, training data, a learning model, a learning history, and the like.

The processor 180 may determine at least one executable operation of the AI apparatus 100 based on information determined or generated by using a data analysis algorithm or a machine learning algorithm. The processor 180 may control the components of the AI apparatus 100 to execute the determined operation.

To this end, the processor 180 may request, search, receive, or utilize data of the learning processor 130 or the memory 170. The processor 180 may control the components of the AI apparatus 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI apparatus 100 so as to drive an application program stored in memory 170. Furthermore, the processor 180 may operate two or more of the components included in the AI apparatus 100 in combination so as to drive the application program.

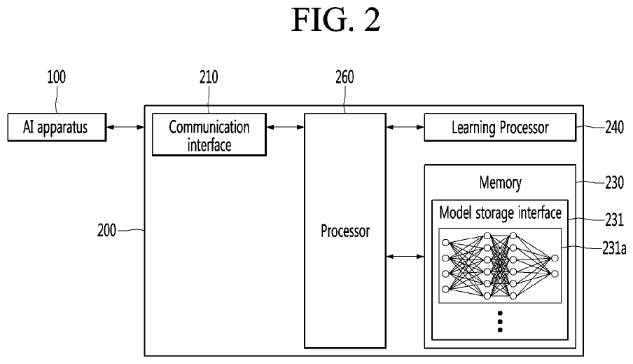

FIG. 2 is a block diagram illustrating an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. Here, the AI server 200 may be included as a partial configuration of the AI apparatus 100, and may perform at least part of the AI processing together.

The AI server 200 may include a communication interface 210, a memory 230, a learning processor 240, a processor 260, and the like.

The communication interface 210 can transmit and receive data to and from an external device such as the AI apparatus 100.

The memory 230 may include a model storage interface 231. The model storage interface 231 may store a learning or learned model (or an artificial neural network 231a) through the learning processor 240.

The learning processor 240 may learn the artificial neural network 231a by using the training data. The learning model may be used in a state of being mounted on the AI server 200 of the artificial neural network, or may be used in a state of being mounted on an external device such as the AI apparatus 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

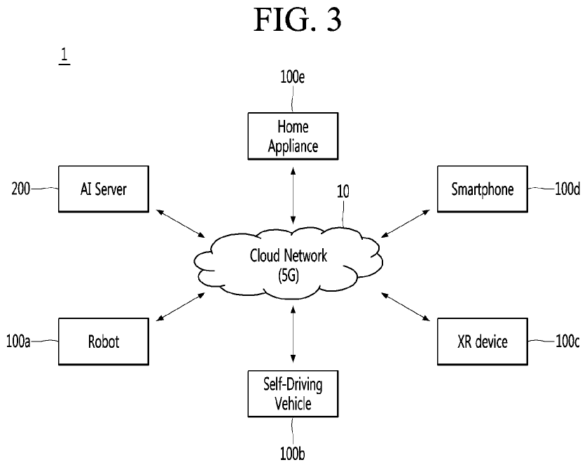

FIG. 3 is a view illustrating an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI apparatuses 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI apparatuses constituting the AI system 1, that is, the robot 100a, the self-driving vehicle 100b, the XR device 100c, the smartphone 100d, or the home appliance 100e through the cloud network 10, and may assist at least part of AI processing of the connected AI apparatuses 100a to 100e.

Here, the AI server 200 may learn the artificial neural network according to the machine learning algorithm instead of the AI apparatuses 100a to 100e, and may directly store the learning model or transmit the learning model to the AI apparatuses 100a to 100e.

Here, the AI server 200 may receive input data from the AI apparatuses 100a to 100e, may infer the result value for the received input data by using the learning model, may generate a response or a control command based on the inferred result value, and may transmit the response or the control command to the AI apparatuses 100a to 100e.

Alternatively, the AI apparatuses 100a to 100e may infer the result value for the input data by directly using the learning model, and may generate the response or the control command based on the inference result.

Hereinafter, various embodiments of the AI apparatuses 100a to 100e to which the above-described technology is applied will be described. The AI apparatuses 100a to 100e illustrated in FIG. 3 may be regarded as a specific embodiment of the AI apparatus 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

Here, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external device to determine the travel route and the travel plan, and may control the driving interface such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving interface based on the control/interaction of the user. Here, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling route by using the recognized surrounding information or object information. The learning model may be learned directly from the self-driving vehicle 100a or may be learned from an external device such as the AI server 200.

Here, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external device to determine the travel route and the travel plan, and may control the driving interface such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving interface based on the control/interaction of the user. Here, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyze three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

Here, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given route without the user's control or moves for itself by determining the route by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

Here, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving interface of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

Here, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

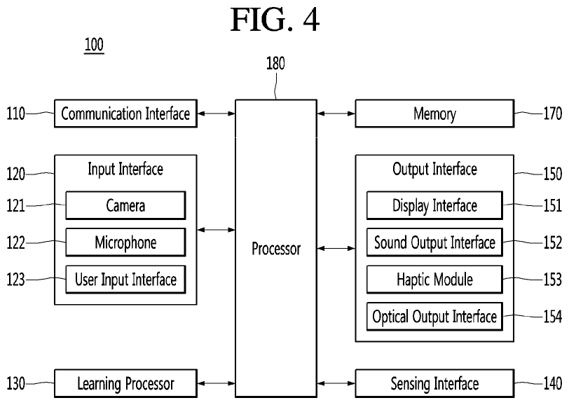

FIG. 4 is a block diagram illustrating an AI apparatus 100 according to an embodiment of the present disclosure.

The redundant repeat of FIG. 1 will be omitted below.

In the present disclosure, the AI apparatus 100 may include an edge device.

The communication interface 110 may also be referred to as a communicator.

Referring to FIG. 4, the input interface 120 may include a camera 121 for image signal input, a microphone 122 for receiving audio signal input, and a user input interface 123 for receiving information from a user.

Voice data or image data collected by the input interface 120 are analyzed and processed as a user's control command.

Then, the input interface 120 is used for inputting image information (or signal), audio information (or signal), data, or information inputted from a user and the AI apparatus 100 may include at least one camera 121 in order for inputting image information.

The camera 121 processes image frames such as a still image or a video obtained by an image sensor in a video call mode or a capturing mode. The processed image frame may be displayed on the display interface 151 or stored in the memory 170.

The microphone 122 processes external sound signals as electrical voice data. The processed voice data may be utilized variously according to a function (or an application program being executed) being performed in the AI apparatus 100. Moreover, various noise canceling algorithms for removing noise occurring during the reception of external sound signals may be implemented in the microphone 122.

The user input interface 123 is to receive information from a user and when information is inputted through the user input interface 123, the processor 180 may control an operation of the AI apparatus 100 to correspond to the inputted information.

The user input interface 123 may include a mechanical input means (or a mechanical key, for example, a button, a dome switch, a jog wheel, and a jog switch at the front, back or side of the AI apparatus 100) and a touch type input means. As one example, a touch type input means may include a virtual key, a soft key, or a visual key, which is displayed on a touch screen through software processing or may include a touch key disposed at a portion other than the touch screen.

The sensing interface 140 may also be referred to as a sensor interface.

The output interface 150 may include at least one of a display interface 151, a sound output module 152, a haptic module 153, or an optical output module 154.

The display interface 151 may display (output) information processed in the AI apparatus 100. For example, the display interface 151 may display execution screen information of an application program running on the AI apparatus 100 or user interface (UI) and graphic user interface (GUI) information according to such execution screen information.

The display interface 151 may be formed with a mutual layer structure with a touch sensor or formed integrally, so that a touch screen may be implemented. Such a touch screen may serve as the user input interface 123 providing an input interface between the AI apparatus 100 and a user, and an output interface between the AI apparatus 100 and a user at the same time.

The sound output module 152 may output audio data received from the wireless communication interface 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user can feel. A representative example of a haptic effect that the haptic module 153 generates is vibration.

The optical output module 154 outputs a signal for notifying event occurrence by using light of a light source of the AI apparatus 100. An example of an event occurring in the AI apparatus 100 includes message reception, call signal reception, missed calls, alarm, schedule notification, e-mail reception, and information reception through an application.

When there is spoiled food in a related-art refrigerator, an internal environment of the refrigerator is improved by using a deodorization filter to remove a smell or by using an antibacterial filter. However, there is no method for preventing food spoilage and thus the fundamental problem is not solved.

The present disclosure predicts a food spoilage probability in an inner space of a refrigerator by using an AI apparatus to reduce a difference between appropriate storage temperature and internal temperature of the refrigerator when internal temperature and humidity of the refrigerator are frequently exposed to an external environment due to frequent opening and closing of the door of the refrigerator, and performs rapid refrigeration when the food spoilage probability is high.

The present disclosure has an advantage of preventing food spoilage in advance since rapid refrigeration is performed when a food spoilage probability is high according to environmental data inputted into the AI model.

The present disclosure relates to an AI apparatus mounted in a refrigerator, including an input interface to obtain environmental data, and a processor which inputs the environmental data into an AI model, and controls the refrigerator to perform rapid refrigeration when a result of the AI model is greater than a first threshold, and rapidly maintains an appropriate storage condition of an inside of the refrigerator based on a food spoilage probability outputted by the AI model.

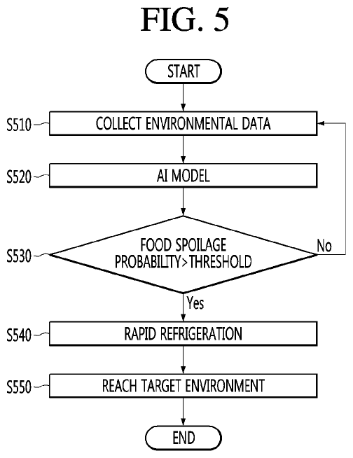

FIG. 5 is a flowchart according to an embodiment of the present disclosure.

Referring to FIG. 5, the processor 180 may control the input interface 120 to obtain environmental data of an inside of the refrigerator (S510). Specifically, the input interface 120 may include a temperature sensor to measure temperature, a humidity sensor to measure humidity, and a camera to obtain a food image. In addition, the environmental data may include at least one data of internal temperature, internal humidity, external temperature, desired temperature, a compartment position, and an internal image of the refrigerator.

In addition, the environmental data may include sequence data which is obtained according to a pre-defined temporal order. Herein, the sequence data may include internal temperature and internal humidity.

In addition, the sequence data may include internal temperature, internal humidity, external temperature, desired temperature, a compartment position, and internal image information.

According to an embodiment of the present disclosure, the refrigerator may include at least one space. Specifically, the input interface 120 may be provided in each space of the refrigerator to obtain environmental data of each space.

For example, the input interface 120 may obtain environmental data for every space by using a temperature sensor, a humidity sensor, and a camera installed in each of the at least one space. In this case, the environmental data may include internal temperature and internal humidity of a corresponding space, external temperature, desired temperature of the corresponding space, a position and internal image information of the corresponding space. The processor 180 may obtain a food spoilage probability by inputting environmental data obtained in each space into an AI model of a corresponding space.

In this case, the processor 180 may perform pre-processing with respect to the internal image information to remove a noise, and may extract feature points through image processing, and may input the internal image information into the AI model.

According to an embodiment of the present disclosure, the role of the input interface 120 may be performed by the sensing interface 140 instead of the input interface 120, and the obtained environmental data may be stored in the memory 170 of the AI apparatus.

The processor 180 may input the environmental data obtained through the input interface 120 into the AI model (S520). A result of the AI model may include a food spoilage probability. In this case, the food spoilage probability may refer to a probability that stored food spoils in the refrigerator. The processor 180 may control the refrigerator to perform rapid refrigeration when the result of the AI model is greater than a first threshold (S530, S540). In this case, the first threshold may be a value that is pre-set according to a purpose of an internal space of the refrigerator. In addition, rapid refrigeration may be a method for adjusting a refrigeration intensity or a refrigeration period of a cooling section for performing refrigeration of the refrigerator, or reducing desired temperature of the refrigerator.

According to an embodiment of the present disclosure, the refrigerator may include at least one space. Specifically, the AI apparatus may include a first AI model corresponding to a first space and a second AI model corresponding to a second space.

The processor 180 may input first environmental data obtained through an input interface of the first space into the first AI model. In this case, rapid refrigeration may be performed in the first space when a result of the first AI model is greater than the first threshold.

In addition, the processor 180 may input second environmental data obtained through an input interface of the second space into the second AI model. In this case, rapid refrigeration may be performed in the second space when a result of the second AI model is greater than a second threshold.

For example, the refrigerator having the AI apparatus mounted therein includes the first space which is a vegetable compartment, and the second space which is a fruit compartment. Hereinbelow, a scenario of the vegetable compartment will be described.

According to an embodiment of the present disclosure, the first input interface mounted in the first space may obtain the first environmental data by measuring internal temperature and internal humidity of the vegetable compartment. The first environmental data may include sequence data including the internal temperature and the internal humidity of the vegetable compartment. In addition, the first environmental data may include sequence data including the internal temperature and the internal humidity of the first space, external temperature, desired temperature of the first space, a position of the first space, and image information of the first space.

A first AI apparatus mounted in the first space has learned a food spoilage probability according to environmental data of vegetables for a purpose of the vegetable compartment, and the first input interface may obtain the first environmental information in the first space. Thereafter, the processor 180 may input the first environmental data into the first AI model. In this case, when a result of the first AI model is greater than the first threshold, rapid refrigeration may be performed in the first space.

According to an embodiment of the present disclosure, the above-described process is performed in the second space in the same way, and the processor 180 may perform rapid refrigeration in the fruit compartment which is the second space when a result of the second AI model is greater than the second threshold. In addition, the above-described process may be performed in each of the plurality of spaces in the refrigerator.

The first threshold of the vegetable compartment and the second threshold of the fruit compartment may be differently set according to a purpose of a corresponding space. Alternatively, the first threshold and the second threshold may be arbitrarily set by a user.

According to an embodiment of the present disclosure, when the internal environment of the refrigerator reaches a target environment after rapid refrigeration is performed, the processor may stop the rapid refrigeration and may switch into a normal refrigeration mode (S550). This process may be performed in each space of the refrigerator provided with the plurality of spaces.

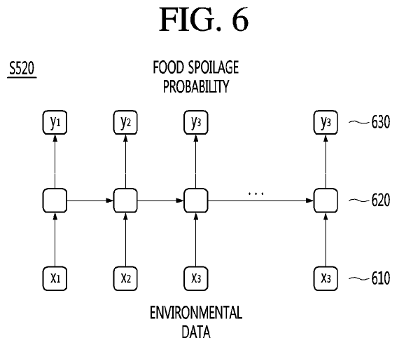

Hereinafter, the AI model will be described with reference to FIG. 6.

FIG. 6 is an AI model according to an embodiment of the present disclosure

Referring to FIG. 6, the AI model may receive environmental data collected from the input interface 120 and may output a food spoilage probability. When the outputted food spoilage probability is greater than a predetermined threshold, the processor 180 may control the refrigerator to perform rapid refrigeration. When the outputted food spoilage probability is smaller than the predetermined threshold, the processor 180 may control the input interface 120 to collect environmental data again.

Specifically, the AI model may include a recurrent neural network (RNN) which is trained by using training sequence data including internal temperature for training and internal humidity for training, and a food spoilage probability labeled on the training sequence data. In addition, the training sequence data may further include external temperature for training, desired temperature for training, a compartment position, and internal image information for training, in addition to the internal temperature for training and the internal humidity for training.

In this case, the RNN is an AI model which is suitable for learning variable data such as sequence data. The RNN may include a hidden state. In this case, the hidden state is information that includes characteristics of previous input data, and, when new input data is inputted, the RNN may output a result reflecting information of whole sequence data by reflecting a previous hidden state.

According to an embodiment of the present disclosure, the AI model mounted in the refrigerator may be formed with the RNN. An input value 610 of the AI model may include environmental data. In this case, the environmental data may include sequence data which further includes internal temperature and internal humidity, external temperature, desired temperature, a compartment position, and internal image information.

The AI model may receive the sequence data, and may output a food spoilage probability as a result 630. In this case, the food spoilage probability may refer to a probability that food spoils within a predetermined time.

For example, referring to FIG. 6, the input value 610 may be environmental data which is sequence data including internal temperature and internal humidity obtained through the input interface 120.

Specifically, X1 to Xt may include a case where environmental data (sequence data) obtained according to the elapsed time is inputted in sequence. When environmental data is inputted into the AI model, the AI model may generate a hidden state 620. In this case, the hidden state may be determined according to a combination of a previous hidden state and a current input value. For example, the hidden state may be determined by a combination of a hidden state generated by the past Xt−1, and Xt.

Thereafter, the AI model which receives the environmental data may output a food spoilage probability as the result 630.

According to an embodiment of the present disclosure, the AI model may include an RRN which is trained to output a higher food spoilage probability as the number of times that a change in the sequence data, including the internal temperature and the internal humidity, is greater than or equal to a predetermined reference value increases. In this case, the predetermined reference value may vary according to a purpose and a kind of the refrigerator, and may be a pre-set value or may be a value that is set by the user.

For example, it is assumed that the door of the refrigerator is frequently opened and closed. After the door of the refrigerator is opened and closed, the input interface 120 may obtain environmental data including internal temperature and internal humidity. A value of the environmental data obtained after the door of the refrigerator is opened and closed is a value that is influenced by an external environment, that is, external temperature and external humidity, and may be different from appropriate storage temperature and humidity of food before the door is opened and closed.

It is common that food spoilage is greatly influenced by storage temperature and humidity. In addition, a fungus propagates well in a high temperature and humidity environment. Accordingly, environmental data (including internal temperature and internal humidity of the refrigerator) obtained through the input interface 120 after the door is opened and closed may indicate that the probability of spoilage of food is high due to the frequent opening and closing of the door of the refrigerator, compared to environmental data obtained before the door of the refrigerator is opened and closed. In addition, every time the frequent opening and closing of the door of the refrigerator is repeated, the internal environment of the refrigerator may not be maintained at lower than predetermined temperature, and the probability of food spoilage may be high.

Considering the above-described point, the AI model may include an RNN which is trained to output a higher food spoilage probability when the number of times that a change in the sequence data obtained through the input interface 120 is greater than or equal to the predetermined reference value increases.

In the above description, it is assumed that the environmental data is internal temperature and internal humidity. However, this should not be considered as limiting, and the environmental data may further include at least one of external temperature, desired temperature, a compartment position, and internal image information, in addition to internal temperature and internal humidity.

In this case, a learning apparatus may train the AI model by using, as an input value, “training environmental data including at least one of external temperature, desired temperature, a compartment position, and internal image information in addition to internal temperature and internal humidity,” and by using, as an output value, a food spoilage probability labeled on the training environmental data.

Specifically, the AI model may include an RNN which is trained to output a higher food spoilage probability when the sequence data including internal temperature and internal humidity, external temperature, desired temperature, a compartment position, and internal image information is in the following conditions:

(1) where the number of times that a difference between desired temperature and internal temperature is greater than or equal to a predetermined reference value increases;

(2) where food determined according to internal image information is food which easily spoils;

(3) where external temperature is higher, or

(4) where the number of times that a change in internal temperature and internal humidity is greater than or equal to the predetermined reference value increases.

In this case, the predetermined reference value may vary according to a purpose and a kind of the refrigerator, and may be a pre-set value or may be a value that is set by the user.

For example, when internal temperature of the refrigerator does not reach desired temperature for a long period due to frequent opening and closing of the door of the refrigerator, food may not be stored at appropriate temperature and may easily spoil.

Accordingly, the AI model may be trained to output a higher food spoilage probability as the number of times that a difference between the desired temperature and the internal temperature is greater than or equal to the predetermined reference value increases as in the condition (1).

In addition, by reflecting that a spoilage speed and a storage condition vary according to a kind of food, the AI model may be trained to output a higher food spoilage probability when food determined according to internal image information is food that easily spoils, as in the condition (2). In this case, the internal image information may be information obtained by using image processing or a feature vector of food obtained by using a deep learning model. In this case, the deep learning model may include a convolutional neural network (CNN).

In addition, when external temperature or external humidity flows into the inside of the refrigerator due to the frequent opening and closing of the door of the refrigerator, and the outside of the refrigerator is in a high temperature and humidity environment, a change in environmental data of the inside of the refrigerator may be great.

Accordingly, the AI model may be trained to output a higher food spoilage probability as external temperature (or external humidity) is higher as in the condition (3). For example, the AI model may be trained to output a higher food spoilage probability when external temperature or external humidity is higher than a predetermined reference value for a long period.

In addition, the AI model may be trained to output a higher food spoilage probability as the number of times that a change in internal temperature and internal humidity is greater than or equal to the predetermined reference value increases as in the condition (4). The expression “as the number of times that the change is greater than or equal to the predetermined reference value increases” includes a case where the change is greater than or equal to the predetermined reference value at least one time, and a case where a high food spoilage probability is outputted according to the number of times the change is greater than or equal to the predetermined reference value.

The AI model which is trained in the above-described method may be mounted in the AI apparatus.

In addition, the processor may input environmental data further including at least one of external temperature, desired temperature, a compartment position, and internal image information, in addition to internal temperature and internal humidity, into the AI model, and may control the refrigerator to perform rapid refrigeration when a result of the AI model is greater than the first threshold,

According to an embodiment of the present disclosure, a plurality of AI models which are trained differently for every specific space by reflecting an internal structure of the refrigerator may be used. In addition, the AI model may grasp a position of an internal space of the refrigerator by using environmental data including a compartment position, and may output a food spoilage probability of the corresponding space.

Specifically, during the training process, a different food spoilage probability may be labeled according to a purpose of a corresponding space and a kind of storage food even when the same environmental data is inputted. That is, an individual AI apparatus may be mounted in each space in the refrigerator including the plurality of spaces, and may be trained.

For example, there may be provided an AI apparatus including a first AI model which is mounted in a first space of a plurality of spaces, and is trained by using first training environmental data collected in the first space, and a food spoilage probability in the first space that corresponds to the first training environmental data, and a second AI model which is mounted in a second space of the plurality of spaces, and is trained by using second training environmental data collected in the second space, and a food spoilage probability in the second space that corresponds to the second training environmental data. In addition, as a result of the AI model, the food spoilage probability in the first space may include a probability that a first main food ingredient stored in the first space spoils according to the first training environmental data, and the food spoilage probability in the second space may include a probability that a second main food ingredient stored in the second space spoils according to the second training environmental data.

In this case, a learning processor for training the AI model may be the learning processor 130 or the learning processor 240 stored in the AI apparatus 100.

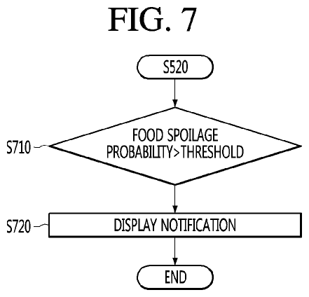

FIG. 7 is a flowchart according to an embodiment of the present disclosure.

Referring to FIG. 7, when a food spoilage probability exceeds the first threshold and rapid refrigeration is performed, the output interface 150 may output a signal received from the processor 180 and may output an appropriate storage condition and a rapid refrigeration notification regarding a space where the rapid refrigeration is performed (S720). A target to which the rapid refrigeration notification is outputted may include a display provided on the refrigerator having the AI apparatus mounted therein, a mobile device connected through the communication interface 110, a smart watch, and an IoT device.

According to an embodiment of the present disclosure, after the rapid refrigeration is performed, the processor 180 may compare environmental data of the inner space with a desired storage condition, and may disable the rapid refrigeration when the environmental information of the inner space reaches the appropriate storage condition.

According to an embodiment of the present disclosure, the processor 180 may determine whether the food spoilage probability outputted by the AI model exceeds an output threshold (S710), and may control the output interface 150 to output a notification when the food spoilage probability exceeds the output threshold. Specifically, when the food spoilage probability exceeds the first threshold in step S530 and the rapid refrigeration is performed (S540), but the food spoilage probability does not exceed the output threshold, the processor 180 may not provide the notification to the user, and may output the notification only when the food spoilage probability exceeds the output threshold. In this case, the output threshold may be set to be larger than the first threshold and may imply a case where the food spoilage probability is very high. That is, when the food spoilage probability is very high, the notification is provided to the user to notify of a state of corresponding food regardless of whether the rapid refrigeration is performed, and to prevent the user from leaving the corresponding food in the refrigerator as it is.

According to an embodiment, when the rapid refrigeration is disabled, the processor 180 may control the output interface 150 to output a rapid refrigeration disabling notification. A target to which the rapid refrigeration disabling notification is outputted may include the display provided on the refrigerator having the AI apparatus mounted therein, a mobile device connected through the communication interface 110, a smart watch, and an IoT device.

In addition, the processor 180 may perform the above-described process in each space in the refrigerator having one or more separated spaces.

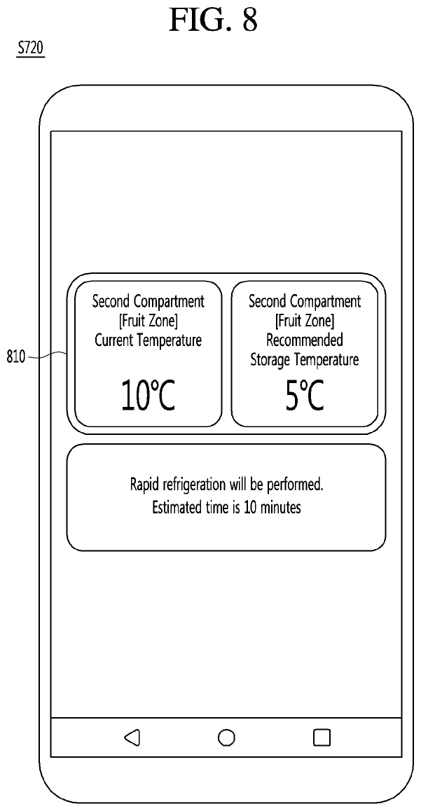

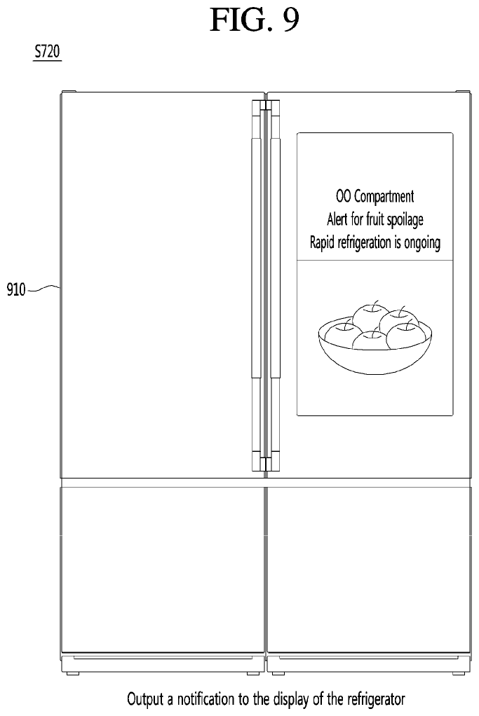

FIGS. 8 and 9 are views illustrating examples of outputs providing notifications to a user according to an embodiment of the present disclosure.

The communication interface 110 may output a notification displaying information regarding whether rapid refrigeration is performed in an inner space of the refrigerator having the AI apparatus mounted therein, current temperature, an appropriate storage condition, and a rapid refrigeration performing time, by communicating with an external device. In addition, the communication interface 110 may output information regarding whether food spoils.

The external device may include a mobile device, a smart watch, and other IoT devices that can communicate with the AI apparatus 100, and all devices that can communicate.

In addition, a signal received from the processor 180 may be outputted by using the output interface 150 mounted in the refrigerator. When the appropriate storage condition is satisfied afterward, the processor 180 may control the output interface 150 to output a notification indicating that the rapid refrigeration is disabled.

According to an embodiment of the present disclosure, the above-described method may be implemented as a processor-readable code in a medium where a program is recorded. Examples of a processor-readable medium may include hard disk drive (HDD), solid state drive (SSD), silicon disk drive (SDD), read-only memory (ROM), random access memory (RAM), CD-ROM, a magnetic tape, a floppy disk, and an optical data storage device.

What is claimed is:

1. An AI apparatus mounted in a refrigerator, the AI apparatus comprising:
an input interface configured to obtain environmental data; and
a processor configured to provide the environmental data to an AI model, and to control the refrigerator to perform rapid refrigeration when a result of the AI model is greater than a first threshold,
wherein the result of the AI model is a food spoilage probability.

2. The AI apparatus of claim 1, wherein the environmental data comprises internal temperature and internal humidity.

3. The AI apparatus of claim 1, wherein the AI model comprises an RNN, and
wherein the AI model is trained by using sequence data comprising internal temperature and internal humidity, and a food spoilage probability labeled on the sequence data.

4. The AI apparatus of claim 3, wherein the AI model is trained to output a higher food spoilage probability as a number of times that a change in the sequence data is greater than or equal to a predetermined reference value increases.

5. The AI apparatus of claim 1, wherein the refrigerator comprises a plurality of spaces,
wherein the AI model comprises a first AI model corresponding to a first space, and a second AI model corresponding to a second space, and
wherein the processor is configured to provide first environmental data obtained in the first space to the first AI model, and to perform rapid refrigeration with respect to the first space when a result of the first AI model is greater than the first threshold, and to provide second environmental data obtained in the second space to the second AI model, and to perform rapid refrigeration with respect to the second space when a result of the second AI model is greater than a second threshold.

6. The AI apparatus of claim 5, wherein the first AI model is trained by using first training environmental data collected in the first space, and a food spoilage probability in the first space that corresponds to the first training environmental data, and
wherein the second AI model is trained by using second training environmental data collected in the second space, and a food spoilage probability in the second space that corresponds to the second training environmental data.

7. The AI apparatus of claim 6, wherein the food spoilage probability in the first space is a probability that a first main food ingredient stored in the first space spoils according to the first training environmental data, and
wherein the food spoilage probability in the second space is a probability that a second main food ingredient stored in the second space spoils according to the second training environmental data.

8. The AI apparatus of claim 1, wherein the processor is configured to control an output interface to output a notification when the food spoilage probability is greater than an output threshold, and
wherein the output threshold is greater than the first threshold.

9. A method for controlling temperature of a refrigerator, the method comprising:
collecting environmental data;
providing the environmental data to an AI model, and performing rapid refrigeration when a result of the AI model is greater than a first threshold,
wherein the result of the AI model is a food spoilage probability.

10. The method of claim 9, wherein the environmental data comprises internal temperature and internal humidity.

11. The method of claim 9, wherein the AI model comprises an RNN, and
wherein the AI model is trained by using sequence data comprising internal temperature and internal humidity, and a food spoilage probability labeled on the sequence data.

12. The method of claim 11, wherein the AI model is trained to output a higher food spoilage probability as a number of times that a change in the sequence data is greater than or equal to a predetermined reference value increases.

13. The method of claim 9, wherein the refrigerator comprises a plurality of spaces,
wherein the AI model comprises a first AI model corresponding to a first space, and a second AI model corresponding to a second space, and
wherein the providing the environmental data to the AI model, and the performing the rapid refrigeration when the result of the AI model is greater than the first threshold comprises:
providing first environmental data obtained in the first space to the first AI model, and performing rapid refrigeration with respect to the first space when a result of the first AI model is greater than the first threshold; and
providing second environmental data obtained in the second space to the second AI model, and performing rapid refrigeration with respect to the second space when a result of the second AI model is greater than a second threshold.

14. The method of claim 13, wherein the first AI model is trained by using first training environmental data collected in the first space, and a food spoilage probability in the first space that corresponds to the first training environmental data, and
wherein the second AI model is trained by using second training environmental data collected in the second space, and a food spoilage probability in the second space that corresponds to the second training environmental data.

15. The method of claim 14, wherein the food spoilage probability in the first space is a probability that a first main food ingredient stored in the first space spoils according to the first training environmental data, and
wherein the food spoilage probability in the second space is a probability that a second main food ingredient stored in the second space spoils according to the second training environmental data.

16. The method of claim 9, further comprising outputting a notification when the food spoilage probability is greater than an output threshold, and
wherein the output threshold is greater than the first threshold.
